(19) United States
(12) Patent Application Publication
(10) Pub. No.: US 2025/0308870 A1
(43) Pub. Date: Oct. 2, 2025

(54) DROPLET DISPENSATION BY FLUID LEVEL AND ENERGY

(71) Applicant: DH Technologies Development Pte. Ltd.

(72) Inventors: Thomas R. COVEY, Newmarket (CA); Chang LIU, Richmond Hill (CA)

(73) Assignee: DH Technologies Development Pte. Ltd., Singapore (SG)

(21) Appl. No.: 18/864,394

(22) PCT Filed: May 12, 2023
(86) PCT No.: PCT/IB2023/054942

§ 371 Date: Nov. 8, 2024

Related U.S. Application Data
(60) Provisional application No. 63/342,303, filed on May 16, 2022.

(51) Int. Cl. H01J 49/00; G01F 25/00; H01J 49/04

(52) U.S. Cl. CPC H01J 49/0009; G01F 25/0092; H01J 49/0445

(57) ABSTRACT

Calibration of a droplet dispenser includes providing a liquid sample including a calibrant and, for each liquid level of a range of different liquid levels providing the liquid sample to a set of wells at the liquid level. Further, over a range of different droplet dispenser parameters, the droplet dispenser is used to dispense droplets from the set of wells into a flowing transport fluid. A mass of calibrant ions generated from the flowing transport fluid is measured using a mass spectrometer. Volumes of the droplets from are determined from the calibrant mass.

### CROSS-REFERENCE TO RELATED APPLICATION

This application is being filed on May 12, 2023, as a PCT International Patent Application that claims priority to and the benefit of U.S. Provisional Application No. 63/342,303, filed on May 16, 2022, the disclosure of which is hereby incorporated by reference in its entirety.

### FIELD

This disclosure relates to mass spectrometry and, in particular, to volume or size of dispensed droplets of a mass spectrometry sample.

### BACKGROUND

Microfluidic dispensing pertains to the control and manipulation of fluids to extract a small volume of fluid from a bulk fluid sample for examination. Microfluidic dispensing emerged in the early 1980s and has been used in a diverse range of fields such as inkjet printing, DNA microarrays, lab-on-a-chip technology, 3-D printing heads, microtiter plate replication and reformatting of pharmaceutical drug libraries, dispensing of individual cells and cell lysates, among other fields.

Microfluidic dispensing has continued to grow and evolve and now is capable of dispensing smaller and smaller volumes of fluids, often via methods that deliver highly precise volumes via non-contact methods. Microfluidic dispensing is particularly useful in fields where reagents are costly or available in limited quantities as well as applications where high speed and throughput is desirable. By way of example, drug development and discovery including high throughput screening (HTS) and the characterization of the pharmacologically relevant administration/distribution/metabolism/excretion (ADME) properties have embraced microfluidic dispensing for these reasons as have fields related to next-generation gene sequencing. More recently the inventors have been incorporating microfluidic dispensing technology to introduce samples to analytical measurement tools such as mass spectrometers.

The basic operation of microfluidic dispensing involves the separation of a small volume of sample material from a relatively larger “bulk” sample. The sample material may be dispensed in different forms, for instance, as a single discrete droplet, group of droplets, mist, or other physical arrangement of the sample material. Depending upon the specific mechanism used to separate the sample material different dispensed forms may be more or less reproducible with each dispensation.

Dispensation by droplet, for instance, has been used to dispense discrete droplets as small as the picoliter range. Some of the most common types of systems for delivering low volume droplets from samples are broadly characterized as jetting or dynamic devices, examples include, for instance: acoustic technology; piezoelectric technology; pressure-driven technology; air-driven pump/valve technology; electric field driven technology; etc. These dispensation devices all transfer a measured amount of energy that is directed into the bulk sample in order to break a desired sample volume from the bulk sample fluid in the form of a droplet or droplets.

### SUMMARY

According to various aspects of this disclosure, a method of calibrating a droplet dispenser includes providing a liquid sample including a calibrant and, for each liquid level of a range of different liquid levels: providing the liquid sample to a set of wells at the liquid level, over a range of different droplet dispenser parameters using a droplet dispenser to dispense droplets from the set of wells into a flowing transport fluid, measuring a calibrant mass of calibrant ions generated from the flowing transport fluid using a mass spectrometer, and determining volumes of the droplets from the calibrant mass.

According to various aspects of this disclosure, a device for calibrating a droplet dispenser includes a droplet dispenser, a sample delivery system positioned to receive droplets dispensed by the droplet dispenser, and a controller connected to the droplet dispenser. The controller is configured to control the droplet dispenser to dispense droplets of a liquid sample from different sets of wells into the sample delivery system using a range of different droplet dispenser parameters. Each set of wells has a different level of the liquid sample. The liquid sample includes a calibrant. The controller is further configured to measure a calibrant mass of the calibrant from ions generated from the liquid sample and detected by an ion detector. The controller is further configured to determine volumes of the droplets from the calibrant mass for each well.

According to various aspects of this disclosure, a method of operating a droplet dispenser includes determining an intended volume of droplet to dispense, determining a liquid level of a sample in a sample well, selecting a droplet dispenser profile from a plurality of droplet dispenser profiles based on the intended volume of droplet, and dispensing droplets into a flow of transport fluid according to parameters in the droplet dispenser profile associated with the liquid level of the sample in the sample well.

According to various aspects of this disclosure, a device that operates a droplet dispenser includes a controller to determine an intended volume of droplet to dispense, determine a liquid level of a sample in a sample well, select a droplet dispenser profile from a plurality of droplet dispenser profiles based on the intended volume of droplet, and dispense droplets into a flow of transport fluid according to parameters in the droplet dispenser profile associated with the liquid level of the sample in the sample well.

### BRIEF DESCRIPTION OF THE FIGURES

FIG. 1A is a block diagram of an example mass analysis system according to various embodiments.

FIG. 1B is a block diagram of example computing resources of FIG. 1A.

FIG. 2 is a schematic diagram of an example methodology for determining sensitivity of droplet volume to droplet dispenser driving parameters, such as burst number and driving voltage, based on liquid level, for various conditions.

FIG. 3 is a schematic diagram of an example methodology for selecting a parameters to drive a droplet dispenser based on well liquid level, fluid conditions, and intended droplet volume.

FIG. 4 is a schematic diagram of an example mass analysis system according to various embodiments.

FIG. 5 is a schematic diagram of an example mass analysis system with a reference standard according to various embodiments.

FIG. 6 is a simplified plot of an example ideal electrospray sample concentration versus signal response relationship for a purified sample fluid without a matrix component.

FIG. 7 is a simplified plot that compares the plot of FIG. 6 to a simplified mass analyzer signal response that suffers from ion suppression due to the effect of sample matrix in the analyzed sample.

FIG. 8 is a diagram of example reference and analyte signals for correcting for ion suppression in an analytical result.

FIG. 9 is a flowchart of an example method of calibrating a droplet dispenser for mass spectrometry.

FIG. 10 is a flowchart of an example method of calibrating a droplet dispenser for mass spectrometry with regard to ionization suppression.

FIG. 11 is a flowchart of an example method of operating a droplet dispenser for mass spectrometry.

FIG. 12 is a cross-sectional view of an example acoustic dispenser coupled to a sample well.

FIG. 13 is a schematic diagram of an example droplet dispenser dispensing microdroplets into a capture probe.

FIG. 14 is a plot of a measured signal of samples including a calibrant.

FIG. 15 is a plot of an example calibration curve.

FIG. 16 is a plot of a signal of a reference standard compound in a mass spectrometer.

FIG. 17 is a plot of a signal of another calibration curve.

FIGS. 18A-18D are plots illustrating an example calibration with respect to a reference standard.

FIGS. 19A-19C are plots illustrating another example calibration with respect to a reference standard.

### DETAILED DESCRIPTION

The amount of energy required to dispense a droplet from a bulk sample fluid is related to the fluid properties of the bulk fluid, with viscosity and surface tension being important considerations. The dispensation parameters that control the energy generated and transferred by a dispensation device into the bulk sample fluid need to be specifically tailored to the fluid properties of a bulk sample fluid in order to deliver a targeted droplet volume that is sufficiently energized to break free from that bulk sample fluid.

Due to the complexity of the problem, the selection of specific dispensation parameters that correspond to a desired droplet volume for a given bulk sample fluid is achieved by an empirical tuning process of one or more dispensation parameters, dispensing one or more droplets, measuring the dispensed volume of the one or more droplets, adjusting a dispensation parameter, and iteratively repeating the sequence until dispensation parameters are identified that consistently deliver the desired droplet volume for the bulk sample fluid. Regardless of the dispensation technology used, the dispensation parameters are often mutually dependent, making this tuning process highly parametric as adjustment of one dispensation parameter may affect the tuning of other dispensation parameters.

Acoustic droplet dispensing is commercially used for transferring liquid samples from one microtiter plate to another, so called plate replication and reformatting. Dispensers are also being developed to transfer samples from test tubes of various configurations into microtiter plates.

As an example of liquid dispensing, acoustic droplet ejection (ADE) or acoustic droplet dispensing (ADD) is a technique used to transfer, contact free, volumetrically accurate and precise droplets from sample wells in a microtiter plate to a corresponding sample well in a second microtiter plate. The use of energy in the form of sound waves allows for the transfer of fluids in the form of discrete droplets to be contact free, volumetrically accurate, and precise when conditions are highly controlled. Typical well densities in the microtiter plates are 96, 384, and 1536 wells per microtiter plate and typical droplet volumes for dispensation are in the 1-25 nL range.

Larger volumes than 25 nL can be dispensed with the expectation that fragmentation of these droplets will occur after desorption due to fluid instabilities. Multiple droplets can be sequentially dispensed to a target well to accumulate to reach a desired dispensing volume. Pharmaceutical research and development organizations use this method extensively to dispense small volumes of compounds, typically dissolved in dimethyl sulfoxide, from their large drug libraries to be further tested in HTS assays screening for biological activity and ADME assays determining pharmacological properties.

Acoustic dispensers, for instance, create sound waves by a piezoelectric vibrator energized with RF power and transferred through a metallic lens to the bottom of a sample well through a coupling fluid. A coupling fluid is used to connect the metallic lens to the bottom of the sample well as Air gaps must be avoided as sound waves rapidly decelerate through gaseous medium. The sound waves propagate through the bottom of the sample well, which can be composed of a variety of compatible plastics or other materials as well as having a wide range of thicknesses and shapes, then travel through the fluid of the sample to the meniscus at the surface. At this point a pressure disturbance occurs as the sound waves decelerate at the liquid-gas interface which will, under the proper conditions accurately launch a droplet of a known volume in a precise and reproducible manner several centimeters above the surface.

Operation of other droplet dispensers, such as pneumatic or pressure-based droplet dispensers may similarly vary in droplet dispensation based on the physical parameters of a liquid sample being dispenses.

Operation of a dispenser may be controlled by adjusting a number of physical parameters that are germane to that dispenser-type. For instance, acoustic dispensers may vary power, duration, or burst rate, focusing location, etc. in order to generate the droplet with the desired volume from the liquid sample. Determining what values to use for these physical parameters in setting the operational parameters of a dispensing device to repeatedly deliver the desired droplet volume from liquids with different fluid properties and depths is a process referred to as calibration. Variations in the sample, plate and environmental properties necessitate the adjustment of the physical parameters to compensate. Determining what values to use for the physical parameters to deliver the desired droplet volume may be considered a calibration process.

In the case of acoustic dispensers, for instance, calibration of the acoustic parameters is required in order to reproducibly dispense accurate and precise droplet volumes. Droplet volume measurement is central to the calibration process. Samples with different fluid properties require unique calibration files and unique energy controlling parameters are required at different depths of a sample. The sound wave frequency, power, energy duration (repetition or burst rate), focus point, and the individual characteristics of the piezo transducer and lens elements in an instrument all affect the volume of the dispensed droplet. The value of these parameters to deliver a specified droplet volume depends strongly on the viscosity and surface tension properties of the bulk solution. For this reason, calibration files are required for different liquids having different viscosities. Calibration settings may also be required for different depths of a particular fluid in a sample well because the energy dissipates as it travels through the fluid to the surface where the energy is deposited to launch the droplet. The calibration files are generally specific to each individual instrument due to variations in the manufacturing of the piezoelectric transducers and the associated lens assembly.

Calibration may be an iterative process which involves adjusting the physical parameters (e.g., acoustic power, frequency, repetition or “burst” rate, and focus of the waves with a lens to a point near the surface of the sample liquid). Their values are affected by the viscosity and/or surface tension of the sample fluid and the power required to launch a droplet. Variations in the sample, plate and environmental properties necessitate the adjustment of the physical parameters to compensate.

After each volume measurement the physical parameters of acoustic power, frequency, and repetition or “burst” rate are iteratively adjusted and the volume measurement repeated. The closer one gets to the correct volume the less adjustment is required. Eventually only one parameter needs fine tuning with all the others remaining at a fixed value reducing the parametric nature of the process.

In addition, the distance the waves must travel to the surface will affect the position of the focal point of the waves which is controlled by positioning the focusing lens. The distance is a function of the volume of sample in the well which can change over time as the sample is dispensed, evaporates, or varies on a sample to sample basis due to the nature of the assay. This distance must be accurately determined for each well and adjusted for by the lens position. This is done by measuring the time it takes for a reflection of a sound wave to return to the piezoelectric emitter which also serves as a detector. The distance to the surface can then be calculated if the speed of sound in the sample fluid is known. For many types of fluid mixtures, the speed of sound is unknown so must be measured by the instrument. Determining the speed of sound in any sample fluid is the first step of the calibration process. Once this is determined for a known bulk sample composition the data is stored and used to determine the fluid depth in all wells to be analyzed. Once the speed of sound is determined in a particular fluid it does not have to be repeated for a given temperature.

Conventional calibration operations are typically done at the factory or in the field by service engineers employing a series of iterative protocols, standardized reference solutions of UV adsorbing compounds or light emitting fluorophores, and spectrophotometers measuring the transmission, adsorption, or emission of light to determine the concentration of the dispensed droplets which can be converted to droplet volume. A predetermined number of droplets are fired from a sample including light emitting or adsorbing reference solution, typically 10-200 droplets, then the sample is diluted to a known volume, much greater than the summed volume of the droplets, and the concentration is determined with a spectrophotometer. When acoustic dispensing is used for plate replicating or reformatting applications, calibration has generally not been a problem because the sample fluid composition is well defined and uniform, commonly 100% DMSO and seldom anything else. The concentration of pharmaceutical library compounds in this solvent is not high enough to substantially affect the fluid viscosity.

In cases where fluid composition is not well defined and may vary between samples, the parameters used to create new calibration files may need to be empirically determined each time a sample having sufficiently different fluid properties is encountered. Small variations can have a large effect for example plasma from different patients or samples from fermentation media taken at different times of the incubation due to the fluid properties introduced by the biological solutes in the aqueous solvent. Samples having different solvent proportions need different calibration files, for example different combinations of alcohols and water. Commercially available acoustically dispensed plate replicator instruments provide calibration files that have been established at the site of manufacture for a limited number of liquids.

New calibration files are also required when different types of sample plates are used having different material compositions and dimensions, the thickness and composition of the bottom of the well where the sound waves traverse are particularly important. In addition, data is required at different depths of fluid within a well. Calibration files may include dispenser driving parameters for 10s, 100s, or more different depths of the fluid in a plate that may include many individual wells (e.g., 384).

Calibration files are stored, reused, and do not have to be replaced on an instrument as long as the sample composition and plate type remains constant. Every instrument will have unique settings due to slight differences in the piezoelectric generator and the metal (typically aluminum) transmitting/focusing lens.

In situations where sample compositions can vary widely and are unpredictable, the calibration problem is a serious obstacle.

This disclosure concerns determining an amount (e.g., mass, concentration, volume, etc.) of a sample provided to a mass spectrometer for analysis, so that analysis results, such as analyte amount or target compound amount, may be accurately determined. The sample amount may be determined with reference to a volume of droplets dispensed by a droplet dispenser that provides the sample to the mass spectrometer. Droplet volume is important to determine. Droplet volume may be sensitive to fluid level in a sample dispensing well and the properties of the fluid, as well as dispenser driving parameters, such as burst rate or number and transducer voltage. Once a droplet volume is determined for a set of fluid conditions, the droplet volume and conditions may be stored with a profile that specifies dispenser driving parameters, such as burst number and transducer voltage, for a range of fluid levels. A profile may be used at a later time to drive a droplet dispenser. A desired droplet volume, and therefore amount of sample, may be used to select a suitable droplet dispenser profile. A set of profiles for various fluid conditions may be constructed, so that desired droplet volume may be readily correlated to driving parameters as indexed by liquid level. Accordingly, calibration may thus be realized, and droplet volume need not be measured for each run of a mass spectrometer.

This disclosure concerns quantifying the sensitivity of droplet dispenser driving parameters to well liquid level and burst number, while recognizing that a myriad of factors may affect droplet volume. These additional factors, such as liquid properties and well geometry, may also be considered.

For purposes of illustrating the above noted problems the present disclosure describes an implementation with acoustic based non-contact dispensers in detail. While the present disclosure and examples are predominantly directed towards implementations employing acoustic microfluidic dispensation devices, the disclosure contemplates a wide variety of dispensation technologies including, without limitation, acoustic technology; piezoelectric technology; pressure-driven technology; air-driven pump/valve technology; and, electric field driven technology. And while acoustic dispensers are operable with parameters such as transducer voltage and burst duration, these parameters really just a representation of the energy imparted to the fluid to generate a droplet. Other dispensation technologies may have analogous parameters that may be taken to represent energy input.

In some embodiments, techniques are described for accurately and precisely measuring the volumes of individual liquid droplets in the picoliter to microliter range. In some embodiments, techniques may include capturing nano- or micro-dispensed droplets in a flowing stream of liquid and transporting them to an atmospheric pressure ion source of a mass spectrometer for measurement. By determining the gravimetric mass of calibration and reference compounds in the droplets and transport fluid the volumes of each droplet can be determined. The measurement is fast enough for real time volume measurement to occur when droplets are dispensed at rates as high as 10 Hz. The techniques described herein may be operated independent of solvent and sample composition and are applicable to biological fluids from a wide variety of sources.

Embodiments described herein may be implemented using a capture probe as an interface to the mass spectrometer in order to capture dispensed droplets for volume measurement. An example of a suitable capture probe includes the “Open Port Probe” (OPP). See, for instance, U.S. Pat. No. 9,632,066 entitled “Open Port Sampling Interface,” US 2016/0299041 entitled “Capture Probe,” and U.S. Pat. No. 9,153,425 entitled “Device for High Spatial Resolution Chemical Analysis of a Sample and Method for High Spatial Resolution Chemical Analysis,” all of which are incorporated herein by reference.

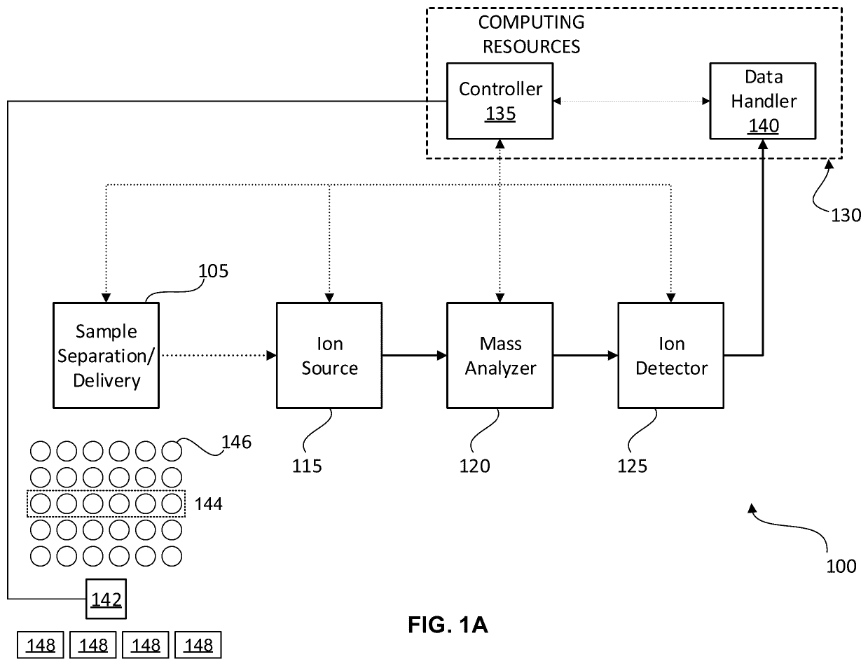

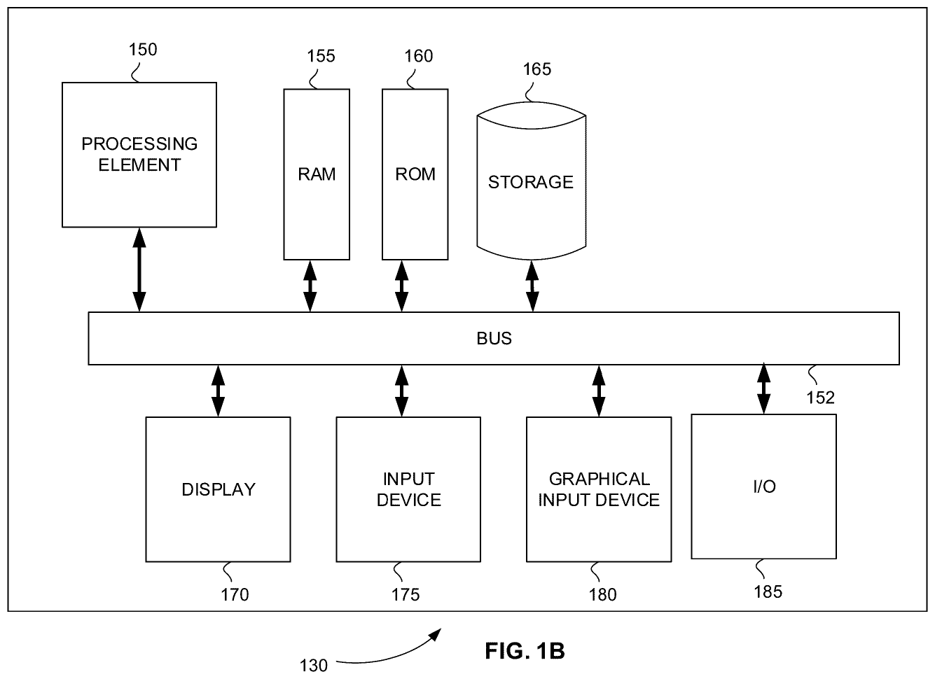

FIG. 1A shows an example mass analysis system 100 according to various embodiments. The mass analysis system 100 is an electro-mechanical instrument for separating and detecting ions of interest from a given sample. The mass analysis system 100 includes computing resources 130 to carry out both control of the system components and to receive and manage the data generated by the mass analysis system 100. In the embodiment shown in FIG. 1A, the computing resources 130 are illustrated as having separate modules: a controller 135 for directing and controlling the system components and a data handler 140 for receiving and assembling a data report of the detected ions of interest. Depending upon requirements the computing resources 130 may comprise more or fewer modules than those depicted, may be centralized, or may be distributed across the system components depending upon requirements. The detected ion signal generated by the ion detector 125 may be formatted in the form of one or more mass spectra based on control information as well as other process information of the various system components. Subsequent data analysis using a data analyzer (not illustrated in FIG. 1A) may subsequently be performed on the data report (e.g., on the mass spectra) in order to interpret the results of the mass analysis performed by the mass analysis system 100.

The controller 135 may include one or more processing elements, such as a microcontroller, a microprocessor, a processing core, a processor, a field-programmable gate array (FPGA), an application-specific integrated circuit (ASIC), a central processing unit (CPU), or a similar device capable of executing instructions. The controller 135 may cooperate with a non-transitory computer-readable medium that may be an electronic, magnetic, optical, or other physical storage device that encodes instructions. The machine-readable medium may include, for example, random access memory (RAM), read-only memory (ROM), electrically erasable programmable read-only memory (EEPROM), a storage drive, an optical device, or similar. In some aspects, the controller 135 may be physically distributed into a plurality of control elements that are operative to act in a coordinated fashion to control the mass analysis system 100.

In some embodiments, mass analysis system 100 may include some or all of the components as illustrated in FIG. 1A. For the purposes of the present disclosure, mass analysis system 100 can be considered to include all of the illustrated components, though the computing resources 130 may not have direct control over or provide data handling to, the sample separation/delivery component 105.

In the context of the present disclosure, a separation/delivery system 105 includes a delivery system capable of delivering measurable amounts of sample, typically a combination of analyte and accompanying solvent sampling fluid, to an ion source 115 disposed downstream of the separation system 105 for ionizing the delivered sample. A mass analyzer 120 receives the generated ions from the ion source 115 for mass analysis. The mass analyzer 120 is operative to selectively separate ions of interest from the generated ions received from the ion source 115 and to deliver the ions of interest to an ion detector 125 that generates a mass spectrometer signal indicative of detected ions to the data handler 140.

It will also be appreciated that the ion source 115 can have a variety of configurations as is known in the art. The present disclosure is mainly directed towards ionization sources that operate by ionizing sample in droplet form, such as the electrospray process.

For the purposes of this disclosure, components of the mass analysis system 100 may considered to operate as a single system. Conventionally, the combination of the mass analyzer 120 and the ion detector 125 along with relevant components of the controller 135 and the data hander 140 are typically referred to as a mass spectrometer and the sample separation/delivery device may be considered as a separate component. It will be appreciated, however, that while some of the components may be considered “separate”, such as the separation system 105 all the components of a mass analysis system 100 operate in coordination in order to analyze a given sample.

FIG. 1B is a block diagram that illustrates example computing resources 130, with which embodiments including the mass analysis system 100 may be implemented. The computing resources 130 may comprise a single computing device, or may comprise a plurality of distributed computing devices in operative communication with components of a mass analysis system 100. In this example, computing resources 130 includes a bus 152 or other communication mechanism for communicating information, and at least one processing element 150 coupled with bus 152 for processing information. As will be appreciated, the at least one processing element 150 may comprise a plurality of processing elements or cores, which may be packaged as a single processor or in a distributed arrangement. Furthermore, in some embodiments a plurality of virtual processing elements 150 may be provided to provide the control or management operations for the mass analysis system 100.

Computing resources 130 also includes a volatile memory 150, which can include RAM as illustrated or other dynamic memory component, coupled to bus 152 for use by the at least one processing element 150. Computing resources 130 may further include a static, non-volatile memory 160, such as the illustrated ROM or other static memory component, coupled to bus 152 for storing information and instructions for use by the at least one processing element 150. A storage component 165, such as a storage disk or storage memory, is provided and, is illustrated as being coupled to bus 152 for storing information and instructions for use by the at least one processing element 150. As will be appreciated, in some embodiments the storage component 165 may comprise a distributed storage component, such as a networked disk or other storage resource available to the computing resources 130.

Optionally, computing resources 130 may be coupled via bus 152 to a display 170 for displaying information to a computer user. An optional user input device 175, such as a keyboard, may be coupled to bus 152 for communicating information and command selections to the at least one processing element 150. An optional graphical input device 180, such as a mouse, a trackball or cursor direction keys for communicating graphical user interface information and command selections to the at least one processing element 150. As illustrated, the computing resources 130 may further include an input/output (I/O) component 185, such as a serial connection, digital connection, network connection, or other input/output component for allowing intercommunication with other computing components and the various components of the mass analysis system 100.

In various embodiments, computing resources 130 can be connected to one or more other computer systems a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis system 100 may be supported by operation of the distributed computing systems.

Computing resources 130 may be operative to control operation of the components of the mass analysis system 100 though controller 135 and to handle the data generated by the components of the mass analysis system 100 through the data handler 140. In some embodiments, analysis results are provided by computing resources 130 in response to the at least one processing element 150 executing instructions contained in memory 160 or 165 and performing operations on data received from the mass analysis system 100. Execution of the instructions contained in memory 155, 160, 165 by the at least one processing element 150 render the mass analysis system 100 operative to perform methods described herein. Alternatively, hardware circuitry may be used in place of or in combination with instructions to implement the techniques described herein. Thus, implementations of the techniques described herein are not limited to any specific combination of hardware and software.

In accordance with various embodiments, instructions configured to be executed by a processing element 150 to perform a method, or to render the mass analysis system 100 operative to carry out the method, are stored on a non-transitory machine-readable medium accessible to the processing element 150.

In various embodiments, the controller 135 is connected to a droplet dispenser 142 that may be coupled to or may form part of the sample delivery system 105, as will be discussed below. The controller 135 is configured to control a droplet dispenser 142 to dispense droplets of a liquid sample from different sets 144 of wells 146 into a sample delivery system 105 using a range of different droplet dispenser profiles 148. The droplet dispenser 142 may be an acoustic droplet dispenser that ejects a droplet from a surface of sample liquid in a sample well, and the volume of the droplet may be sensitive to acoustic transducer voltage (i.e., amplitude) and burst number (i.e., duration of energy applied). Droplet volume sensitivity to burst number may be due to the energy imparted by the burst. Generally, the longer the burst, the greater energy imparted and thus the greater the droplet size.

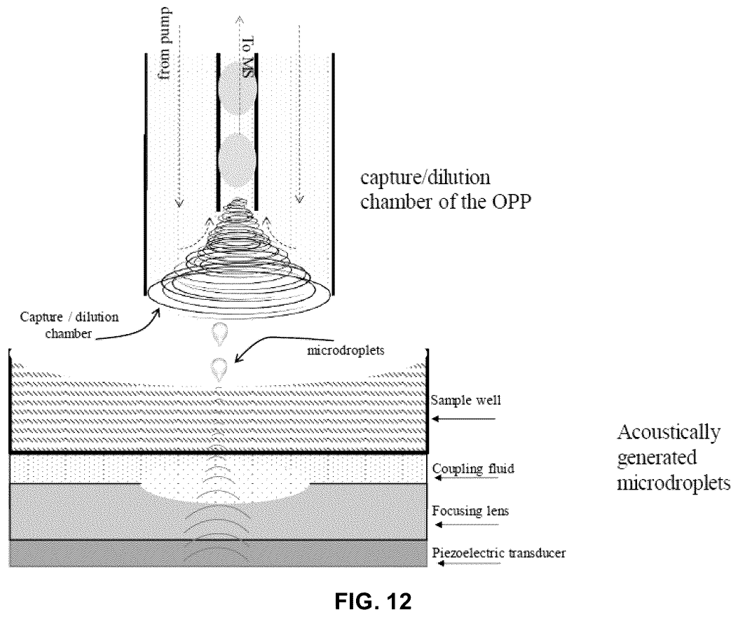

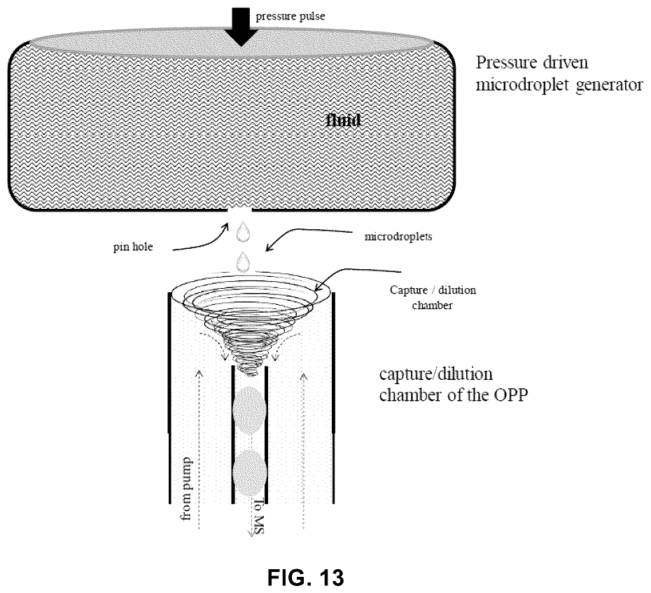

FIG. 12 shows an example acoustic dispenser coupled to a sample well that is dispensing microdroplets into a sample processing region of a co-axial capture probe (OPP). FIG. 13 shows an example droplet dispenser employing a measured force to force liquid sample through a small pinhole aperture.

Each set 144 of wells may have a different level (depth) of the liquid sample. Other conditions may also be varied among the set 144 of wells, such as type of well, type of sample, and other factors that may have an effect on droplet dispensing. Each well 146 in a set 144 may be provided with the same conditions.

A droplet dispenser profile 148 may associate dispensing parameters with a range of liquid levels and well conditions. Dispensing parameters may control energy imparted to a fluid to generate a droplet. For example, a droplet dispenser profile 148 may associate a burst number (i.e., a duration of energy applied) and the droplet dispenser transducer voltage at various liquid levels to the type of liquid sample and the type of well. Each profile 148 may correspond to a set of conditions, so that droplet volume may be quantified and stored with the profile 148 and the profile 148 may be referenced during future mass spectrometer operations (using the system 100 or another system) to enable dispensation of intended droplet volumes without further measurement. It is contemplated that liquid level in the well is a primary factor in dispensed droplet volume. In addition, type of sample may indicate other characteristics, such as viscosity, specific gravity, etc. that may be expected in different sample matrixes (e.g., blood plasma) and that may also affect droplet volume. Further, wells of different types may be made of different materials and have different dimensions which may also affect dispensed droplet volume.

Accordingly, each well 146 in a set 144 may be controlled to dispense droplets according to a different profile 148, so that droplet ejection for the conditions in the set 144 may be quantified over a range of dispensing parameters, such as burst number and driving voltage, for a range of different liquid levels. This is to determine the sensitivity of droplet volume to burst number and driving voltage for a particular fluid level and other conditions, in other words, the sensitivity of droplet volume to energy imparted to the source fluid by the dispenser for a particular fluid level and other conditions.

A plurality of sets of wells 146, where each set 144 has the same fluid level and conditions and where each well 146 in a given set 144 is driven by a different parameters, is one example of creating an association of dispensing parameters with well conditions. Such an association may be established based on other quantification methodologies.

Once a suitable association is established, the sample fluid in the wells may be dispensed according to the profiles and as—dispensed droplet volumes may be measured with reference to a calibrant.

The liquid sample in the different sets 144 of wells 146 includes a calibrant. The controller 135 is further configured to measure a calibrant mass of the calibrant from ions generated from the liquid sample and detected by an ion detector 125. The controller 135 is further configured to determine volumes of the droplets from the calibrant mass for each well 146. Since transport fluid flow rate, droplet dispensing volume, and calibrant concentration are known/controllable, measured calibrant mass can readily be used to compute droplet volume. As such, droplet volume may be determined for the conditions established for a given well 146 and for a given set of parameters used to drive the dispenser 142. Each profile 148 may be associated with the relevant conditions and the resulting droplet volume for future reference. For example, a profile 148 may be associated with conditions, such as fluid type and well type, and may specify driving parameters, such as burst number and transducer voltage, at a range of liquid levels.

Thus, during a subsequent use of the system 100, or a comparable system, a profile 148 may be selected based the intended or desired volume of droplet to dispense and the actual conditions of the sample well, such as the type of liquid sample, the type of well, and/or other conditions. The selected profile 148 may then be used by the controller 135 to dispense droplets of expected volume by, for example, providing the burst number and the operational droplet dispenser transducer voltage that should be used at a measured well liquid level.

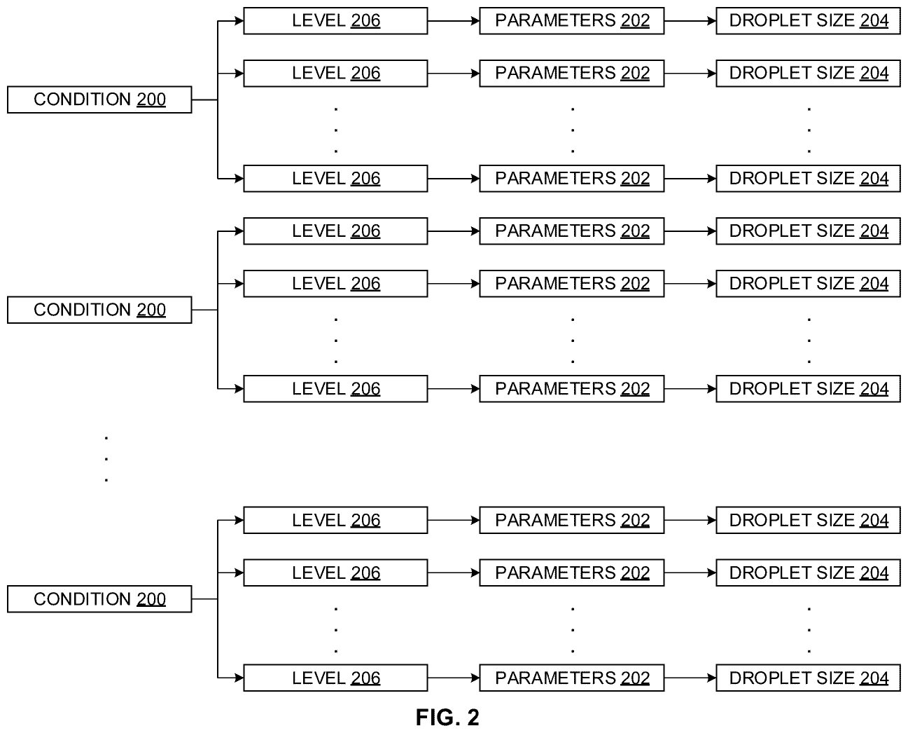

FIG. 2 shows an example methodology for determining sensitivity of droplet volume to droplet dispenser driving parameters, such as burst number and driving voltage, over a range of liquid levels for various sample fluid conditions.

For a given set of conditions 200, such as fluid properties or type and/or the type of sample well, a range of liquid levels 206 is determined. A set of droplet dispenser operational parameters 202, such as burst number and transducer voltage, are associated with various liquid levels 206. Accordingly, each combination of dispenser parameters 202, liquid level 206, and conditions 200 may represent a unique set of factors that affect volume of droplet ejected.

As such, a droplet dispenser may be driven according to parameters 202 for the different sets of conditions 200, where the specific parameters are selected for a current liquid level 206. The resulting droplet volume 204 may be measured using a calibrant.

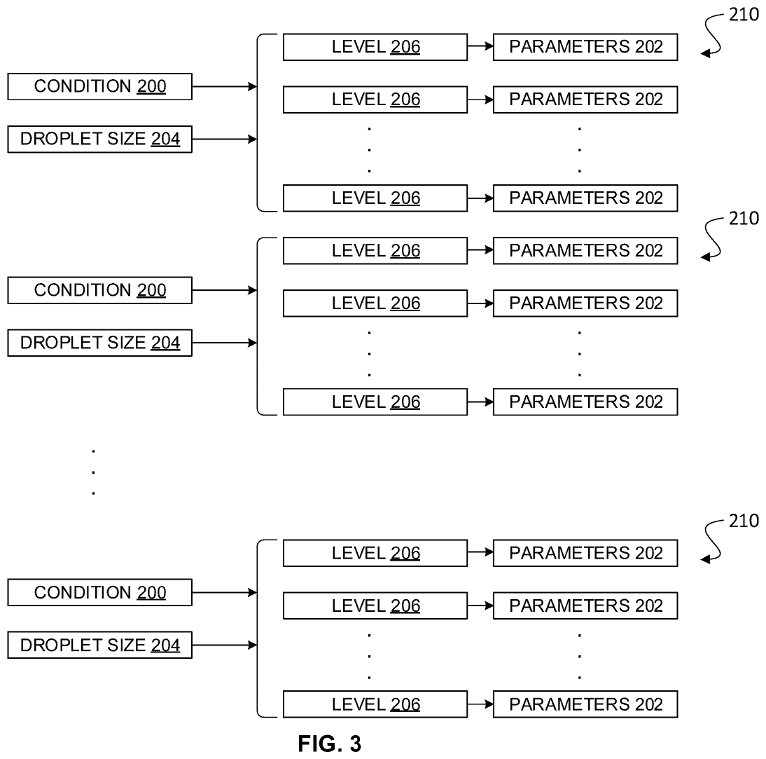

FIG. 3 shows an example methodology for selecting a parameters to drive a droplet dispenser based on fluid conditions, liquid level, and intended droplet volume.

For a given fluid condition 200 present a sample well, an intended droplet volume 204 may be desired. Accordingly, dispenser driving parameters 202 for a measured well liquid level 206 at the condition 200 and droplet volume 204 may be looked up. For example, a given type of well and fluid (i.e., a condition 200) and a desired droplet volume 204 may be used to determine a range of parameters 202, over a range of well liquid levels 206, to drive the droplet dispense to achieve this droplet volume 204.

This data structure may be used to establish a library of droplet dispensing profiles where each profile associates a burst number and a droplet dispenser transducer voltage to a range of liquid levels 206 and at a condition 200 for an intended droplet volume 204. A dispenser profile 210 may be considered a set of correlated liquid levels 206 and parameters 202 that are useable for a condition 200 and intended droplet size 204.

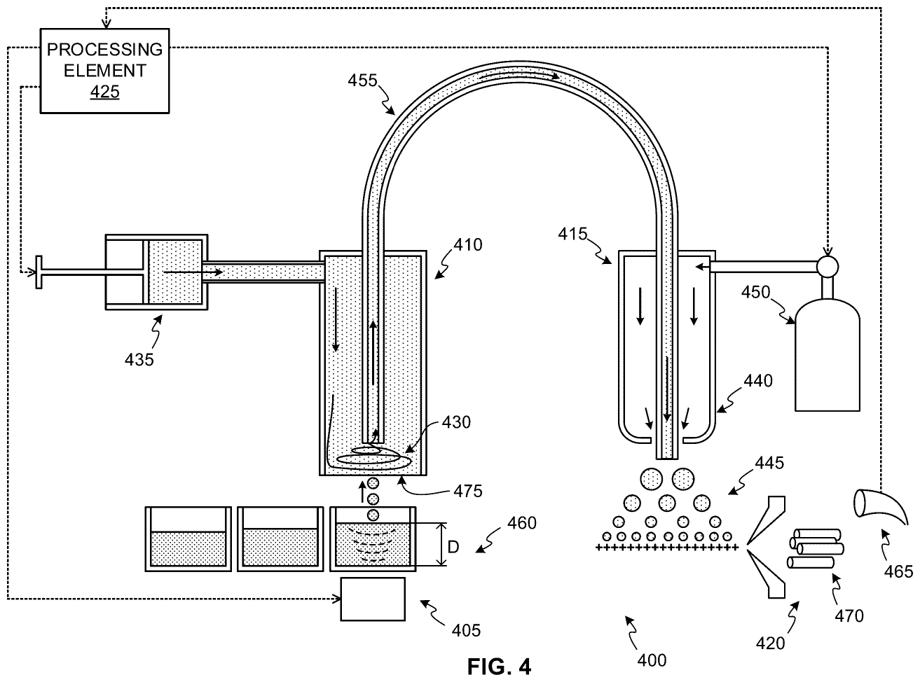

FIG. 4 depicts an example mass analysis system 400 according to various embodiments of the present invention. The system 400 includes a sample delivery device 405, a sample processing component 410, an ionization component 415, a mass spectrometer 420, and a processing element 425, which may include a controller and/or similar hardware and/or software, as discussed elsewhere herein.

The sample delivery device 405 controls the amount of sample delivered. The sample delivery device 405 may include an acoustic droplet dispenser controllably associated with a plurality of sample wells 460. As such, sample delivery may be achieved by a burst of acoustic waves imparting energy into the surface of the fluid sample thereby ejecting a droplet having a particular volume. The amount of sample entering the processing region can be varied by controlling dispenser operational parameters, such as frequency, power (e.g., transducer voltage), direction, duration, burst number, focusing location, and/or similar parameters. By varying the amount of sample dispensed, the dilution of the sample in the sample processing component 410 is changed.

The sample processing component 410 receives ejected droplets of a sample and provides a region 430 for adjustment of concentration of the sample for suitable or optimal electrospray ionization. The sample processing region 430 may be adjacent an open port sampling interface 475 into which an acoustic droplet dispenser 405 dispenses droplets of a sample at a controllable droplet volume, droplet burst duration, droplet dispensation rate, or a combination of such. In some aspects, sample processing may continue outside of the sample processing region 430. For instance, sample processing, such as dilution, may occur through a transport conduit 455 connecting the sample processing component 410 to the ionization component 415.

The transport conduit 455 conveys the sample to the ionization component 415, which includes a pressurized gas source 450 and a gas expansion region 440 to draw the sample to a charged droplet generation region 445 for electrospray ionization (ESI).

In this embodiment, the sample processing component 410 includes a fluid delivery pump 435 to provide the transport fluid for sample processing and transport. The flow of the transport fluid into this region can be varied with the pump thereby altering the degree of dilution of the sample and rate of transport.

The ionization component 415 creates charged droplets from the processed sample. The ionization component 415 may include a pressurized gas source 450 and a gas expansion region 440 to create a pressure drop to draw the sample from the processing region 430 to a charged droplet generation region 445 for ESI. Control of this gas flow allows the varying of the liquid flow out of the processing region 430 thereby offering an additional way to alter the degree of dilution in the processing region 430 and/or the transport conduit. Gas and fluid flow may be changed together, so as to adjust dilution while maintaining stable ionization.

The mass spectrometer 420 may be an atmospheric pressure ionization mass spectrometer. The mass spectrometer 420 receives the sample ions, filters the sample ions by m/z, and measures the amount of ions created. The mass spectrometer 420 may include an ion detector 465, a mass filter 470, and/or like components. The ion detector 465 may be configured to generate a mass spectrometry signal indicative of ions detected from electrically charged droplets generated from a flow of solution.

The processing element 425 is communicatively coupled to the mass spectrometer 420 and configured to interpret signals generated by the mass spectrometer 420. The processing element 425 may further be communicatively coupled to the sample delivery device 405, the fluid delivery pump 435, and the pressurized gas source 450 to control these components 405, 435, 450. An automatic feedback loop may be established.

During a profiling process, the processing element 425 may control the droplet dispenser 405 to eject droplets according to a range of parameters (e.g., burst number and excitation voltage) for a range of liquid levels D in wells 460. The liquid in the sample well 460 is provided with a calibrant of known concentration and the flow rate of the transport fluid in the system is controlled (e.g., held constant), so that the processing element 425 may reference the signal from the mass spectrometer 420 to determine a measured amount of calibrant. The processing element 425 may then compute droplet volume.

Well liquid level D may be measured using conventional techniques, such as optical or sound-based techniques. A plurality of wells with a range of different liquid levels D may be used. Other liquid conditions may also be varied, such as type of liquid and type of well.

A depth measurement may be performed by measuring the time it takes for a reflection of a sound wave, delivered up through the bottom of the sample well, to return to the piezoelectric transducer which serves as both the emitter and detector of the sound waves. Reflections of a portion of the emitted sound waves occurs at each point where the transmitting medium changes state, from solid to liquid to gas. A reflection occurs from the bottom of the well plate, from the transition from the solid well plate bottom to the sample liquid, and from meniscus at the surface of the liquid sample where the most intense reflection is observed. This allows the speed of sound to be determined through both the plate bottom and the liquid sample when known plate bottom thicknesses and known liquid depths are tested.

Once the speed of sound is determined through a plate of a material and thickness those values remain constant for all plates of this type and the information is stored. Once the speed of sound is determined through a liquid medium then that remains constant for all samples of this bulk composition and the information is stored. The entire process, including the mechanical refocusing of the lens, takes on the order of tens of milliseconds which allows for this measurement to be done on every sample well prior to dispensing.

During operation, a profile that correlates driving parameters to well liquid level may be selected for the operational conditions, such as the type of liquid and type of well, and the intended droplet size. The processing element 425 may determine the liquid level D of a sample in a well 460 and then, with reference to a desired droplet volume, look up suitable parameters for operation of the droplet dispenser 405. Accordingly, a suitable burst number and excitation voltage for the droplet dispenser 405 may be determined to achieve the desired droplet volume. Droplet volume may thus be determined without requiring a separate sizing process using the sample.

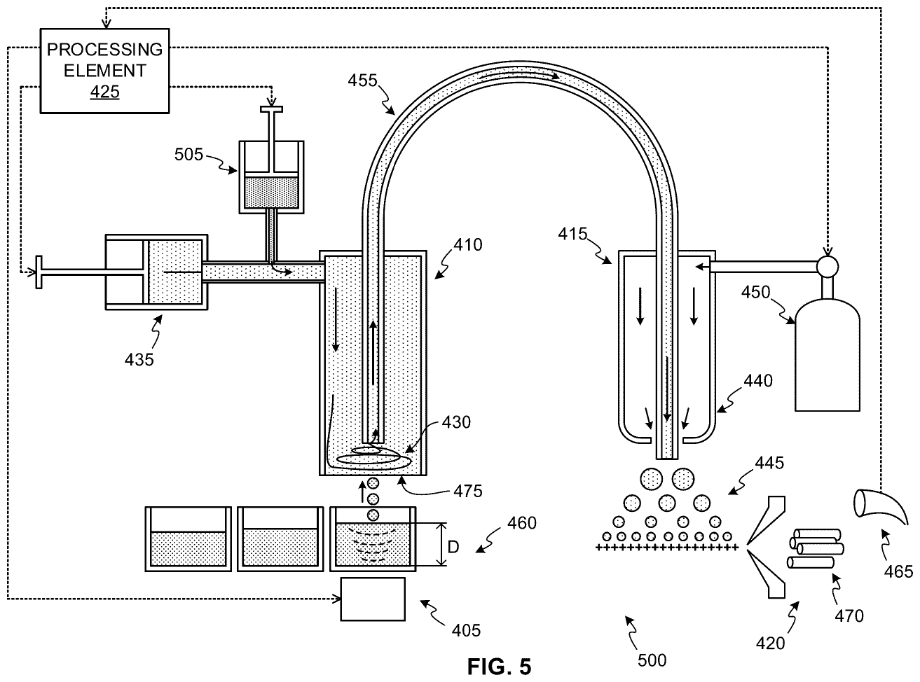

FIG. 5 depicts an example mass analysis system 500 according to various embodiments of the present invention. The system 500 is similar to the system 400, with like components having like terminology and/or like reference numerals. The description of the system 400 may be referenced for detail not repeated here.

A reference standard may be introduced at the sample processing component 410. The system 500 may include a reference standard pump 505 connected to a transport fluid delivery conduit that conveys transport fluid from the fluid delivery pump 435 to the sample processing component 410. The processing element 425 may be connected to the reference standard pump 505 to control delivery of the reference standard. The reference standard may be mixed with the transport fluid at a controlled concentration governed by the rates of flow provided by the pumps 435, 505.

The reference standard may be a compound having similar ionization performance to the analyte expected to be provided to a well 460 during operation, and may be distinguished from such analyte by mass or other selective property by the mass spectrometer. For instance, in some embodiments the reference standard may be an isotope-labeled analog of a target sample analyte. In some aspects, the reference standard may be a compound having greater ionization performance sensitivity than the sample analyte(s), such that detection of the compound will be impacted by ion suppression before the sample analyte(s). These aspects may be useful, for instance, where samples are known to have general characteristics or composition and a reference standard has been identified that has the same or more sensitive ionization performance to the expected sample composition under expected test conditions (e.g., temperature, solvent, etc.).

For instance, where the sample fluid has known or assumed general properties or components, the reference standard may be selected based on an expected property or component of the sample fluid. For instance, the reference standard may be selected to have sensitive ionization performance based on the known property or component of the sample fluid. As an example, in the case where the sample fluid contains proteins, such as a blood plasma matrix, the reference standard may be sensitive to the assumed presence of the proteins such that it serves as an early warning indicator of insufficient dilution of the blood plasma matrix. As another example, in the case where the sample fluid contains surfactants, the reference standard may be sensitive to the assumed presence of the surfactants. As another example, in the case where the sample fluid is eluted from a column that utilizes an elution fluid that is not typically considered compatible with mass spectrometry, the reference standard may be sensitive to the components of the elution fluid that are understood to interfere with ionization.

The ion detector 465 of the mass spectrometer 420 generates a mass spectrometry signal that includes a component attributable to the reference standard based on a concentration of the reference standard in the flow of the solution. As the reference standard is introduced at a known concentration, a known expected reference signal would be measurable at the mass spectrometer 420 provided that ion suppression does not occur. That is, an ideal expected reference signal exists due to the introduction of the reference standard. As such, processing element 425 may be configured to determine a deviation of an actual signal attributable to the reference standard from the ideal expected signal to detect the presence and degree of ionization suppression. Little or no deviation may indicate little or no ionization suppression. A significant amount of deviation may indicate significant ionization suppression.

During a profiling process, in which wells 460 with different liquid levels are used to eject droplets according to a range of dispenser parameters to measure droplet volume, the processing element 425 may correct the component of the mass spectrometry signal attributed to the calibrant in the well 460 with the component of the mass spectrometry signal attributed to the reference standard. As such, a compensated calibrant amount may be used to determine a more accurate droplet volume that accounts for ionization suppression.

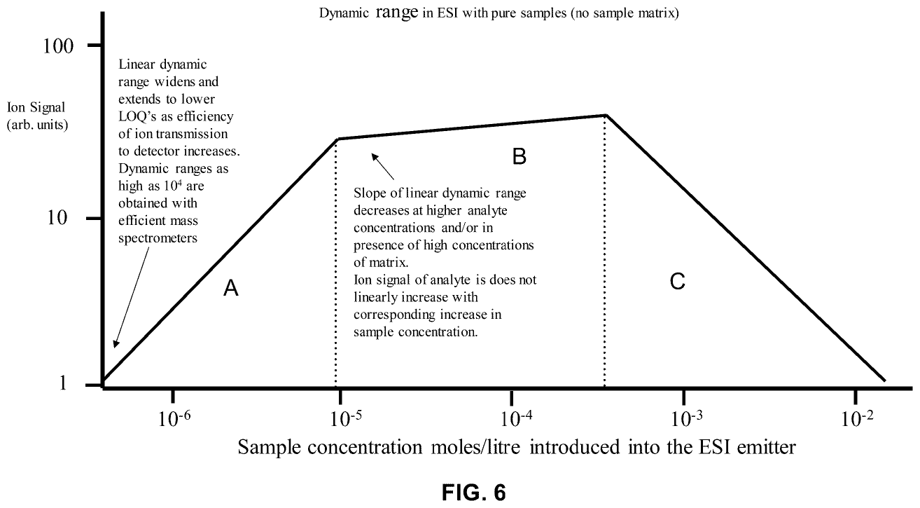

Further, with regard to ionization suppression, FIG. 6 is a simplified plot illustrating the classically understood electrospray sample concentration versus signal response relationship for a purified sample fluid without a matrix component. FIG. 6 may be considered a calibration curve that correlates sample amount to mass spectrometry signal under solution composition conditions for ideal (or sufficient) ion production from charged droplets. At low analyte concentrations, typically below about 10⁻⁵ M in a relatively clean matrix (Region A), the signal response to sample concentration is linear. The linear relationship typically holds across analyte concentrations of about 3 to 4 orders of magnitude depending upon the lowest levels of detectable analyte concentrations which are defined by the lowest limit of detection of a system.

The lower the limit of detection (LoD) the broader the measurable linear dynamic range. Accordingly, the effective linear dynamic range of a mass analysis system may widen and extend to lower limits of quantitation (LoQ) with increased efficiency of ion transmission to the system detector. Dynamic ranges as high as 10⁴ are obtained with efficient mass spectrometers that are able to detect lower ion signals. At the limit, the sensitivity of the detector is counterbalanced with noise and so it is still desirable in many cases to increase ion signal to improve overall signal-to-noise ratio (S/N).

At a concentration of about 10⁻⁵ M for the analyte of interest the signal increase with increasing concentration levels off (Region B), i.e. the slope of signal increase to sample concentration decreases. Typically, the relationship between signal and concentration in Region B may start to move into a non-linear relationship as the suppression effect increases with increasing concentration. The ion signal of analyte does not linearly increase with corresponding increase in sample concentration in Region B due to competition for surface sites on the periphery of the high field ion emitting droplet.

The linearity levels out when analyte concentrations, or other competing compounds in solution, reach about 10⁻⁵ M. Above analyte concentrations of 10⁻⁴ M the severe suppression region is entered where either its or the concentrations of other components continues to increase. While not illustrated in FIG. 6, in some cases in the latter portion of region B the response may remain constant even with increasing analyte concentration. At a point above about 10⁻⁴ M the slope of the calibration curve becomes negative as shown in FIG. 2 (Region C). In this region of severe suppression, the signal response decreases with increasing analyte concentration until, at some point, full suppression of response signal occurs.

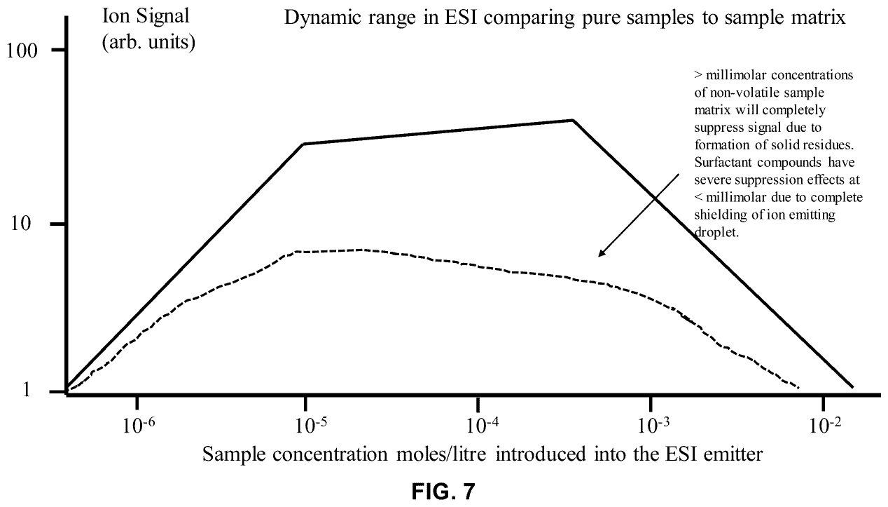

FIG. 7 is a simplified plot that compares the idealized plot of FIG. 6 to a simplified mass analyzer signal response that suffers from ion suppression due to the additional effect of sample matrix in the analyzed sample. In general, the presence of a sample matrix will have the effect of lowering the maximum detectable ion signal for a given sample and may have additional suppression effects. This effect, known as the matrix effect, can occur when typically greater than millimolar concentrations of non-volatile sample matrix is included in the sample. The sample matrix can completely suppress signal due to formation of solid residues. Surfactant compounds in particular have severe suppression effects at lower than millimolar concentrations due to complete shielding of the ion emitting droplets.

Ionization suppression is insidious in nature because its occurrence is unpredictable from sample to sample if samples vary in their composition which is almost always the case in biological systems. The complete composition of biological and other samples for analysis is never fully understood a priori. Sample purification methods such as solid phase extraction, liquid-liquid extraction, and liquid chromatography can help reduce its occurrence but not eliminate it. This is largely because to remove the offending sample components, their chemical nature must be understood ahead of time to selectively improve or optimize the purification method.

When analyte concentrations are outside the linear dynamic range or extraneous sample components are present causing ionization suppression it is desirable to know, when the sample is being analyzed, if ionization suppression is occurring and correct conditions to account for the deviation from the linear calibration. Methods to do this are primarily after-the-fact, i.e., after the analysis is complete and deviations from linearity are observed action is then taken and the analysis repeated to see if the corrections to the method improved the accuracy and precision of the analysis.

Ionization suppression is typically addressed by the use of extensive sample pre-purification protocols including solid phase extraction, liquid-liquid partitioning, antibody affinity pull downs of targeted components, and high-performance liquid chromatography. Determining whether a purification procedure will solve the suppression problem requires conducting test experiments using the protocol and iteratively adjusting and fine tuning the separations protocols until the suppression problem can be proven to be eliminated. King et al. in “Mechanistic investigation of ionization suppression in electrospray ionization” Journal of the American Society for Mass Spectrometry 11, no. 11 (2000): 942-950 describe this situation and its implications clearly. King devised an approach for determining where in a high-performance liquid chromatography (HPLC) chromatogram regions of high ionization suppression occur due to contaminants co-eluting with analytes. King's methods serve as an aid to experienced analytical scientists who are customizing sample extraction procedures and chromatographic separations for specific analytes and biological matrices. This approach is time consuming, requires expertise, and is empirical by nature nevertheless it represents the state-of-the-art at this time. In many application areas where expertise and time are key determinants, for example clinical hospital laboratories, advanced analytical techniques of these types can be burdensome. Also, these methods do not provide a route to the direct analysis of samples without pre-purification which in many cases distorts the chemical composition of the sample to be analyzed in unknown ways.

If samples are not sufficiently purified by HPLC or other technique the linear dynamic range shifts to higher analyte concentrations. In presence of 10-5 M concentrations of matrix the signal of analyte is reduced. Competition for surface sites on the periphery of the high field ion emitting droplet. At concentrations greater than millimolar non-volatile sample matrix will completely suppress signal due to formation of solid residues. Surfactant compounds have severe suppression effects at <millimolar due to complete shielding of the ion emitting droplet.

Although there are variations in these values depending on the chemical characteristics of the analyte, the presence of other dissolved solutes, and the nature of the supporting solvent, these concentration mileposts remain remarkably consistent. The root causes of ionization suppression reside in both the chemical properties of the system and its physical state. The surface tension and viscosity of liquids and surface activity, solubility, and ionic character of compounds will vary from situation to situation introducing an element of unpredictability for the onset of ionization suppression. The physical state of the sample that defines the conditions under which ion production can occur are constants involving critical electric field strengths and colligative properties defining whether a system is in the solid or liquid state.

The role that the chemical and physical properties of the system play in the ionization suppression phenomena can be explained from basic ion evaporation theory as will be described. Components of the sample in solution other than the analyte will lower the signal from the compound of interest at concentrations in the non-linear range. If the concentration of the endogenous compounds is high enough eradication of all signal from the sample will occur. In general, compounds having surfactant properties have a dominant effect over all other typical chemical species.

Embodiments of the present disclosure enable the analysis of raw samples unmodified by sample purification or chromatographic separation by assessing the degree of suppression occurring and taking appropriate measures in an immediate real time fashion too correct the conditions for ion production and proceed with the sample analysis in an automated uninterrupted fashion. In order to ameliorate the suppression problem intervention in the process of ion production must have the net effect of creating conditions for suitable or optimal ion production at the stage when ions are produced.

Some embodiments of the present disclosure enable the analysis of eluant produced by a liquid separator without additional purification procedures. These embodiments may be useful, for instance, where an LC or capillary electrophoresis (CE) buffer may be considered incompatible with analysis by mass spectrometry. As an example, some buffers may contain surfactants which may lead to severe suppression effects using conventional techniques.

With reference back to FIG. 5, during a profiling process, a liquid having properties expected during operation may be provided to a set of wells 460. Such a liquid provides for accurate profiling of droplet volumes in that fluid properties are close to those expected during operation. Further, such a liquid may be susceptible to ionization suppression, and particularly ionization suppression that affects accurate quantification of the calibrant provided to the wells 460 to facilitate the profiling process. Accordingly, a reference standard may be provided to compensate for ionization suppression.

The processing element 425 may be controllably coupled to the reference standard pump 425 to introduce a reference standard of predetermined reference concentration into the transport fluid flowing through the sample processing component 410 and transport conduit 455.

The processing element 425 may obtain a reference signal from ions of the reference standard generated from the flowing transport fluid using the mass spectrometer 420. The processing element 425 may thus use the reference signal to correct a measured calibrant mass by correcting the calibrant signal captured by the mass spectrometer 420.

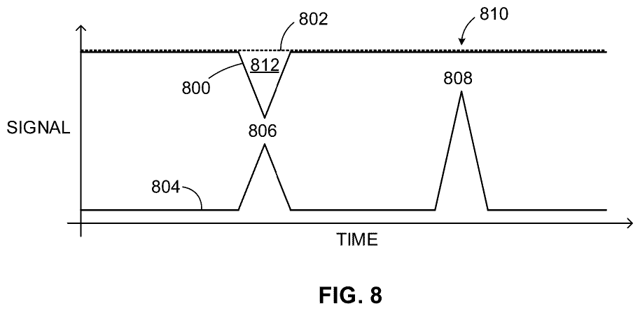

FIG. 8 is a diagram of an example detected reference signal 800, an example expected reference signal 802, and an example calibrant (or analyte) signal 804. A magnitude of a deflection of the suppression reference standard signal 800 may be evaluated to obtain a quantitative estimate of how much suppression is taking place and thus affecting the calibrant signal 804. Analysis of the calibrant signal 804 alone likely cannot differentiate between an accurate signal and a signal that is too low due to ion suppression.

As shown at time 806, the detected reference signal 800 deviates from the expected reference signal 802 thereby indicating ion suppression. Therefore, the calibrant signal 804 at this time 806 is also affected by ion suppression and is not by itself an accurate measure of the calibrant in the liquid being used to profile the droplet dispenser. At time 808, the detected reference signal 800 does not deviate from the expected reference signal 802, as shown at 810. This indicates no appreciable ion suppression. Hence, the calibrant signal 804 at this time 808 may be considered an accurate measure of the calibrant in the liquid being used to profile the droplet dispenser, as far as ionization suppression is concerned. Corrective measures may be taken based on the quantitative estimate provided by the detected reference signal 800 as compared to the expected reference signal 802.

For example, the calibrant signal 804 may be adjusted based on the deviation of the detected reference signal 800 from the expected reference signal 802. A loss 812 in the detected reference signal 800 with respect to the expected reference signal 802 during a time 806 of ion suppression may correspond to a loss in the calibrant signal 804 at the same time 806. Hence, the calibrant signal 804 at this time 806 can be adjusted based on the loss 812 to obtain a compensated calibrant signal that would be similar to the calibrant signal 804 at a time 808 when ion suppression does not occur. That is, the loss 812 in the reference signal may be referenced to a calibration curve to account for calibrant molecules lost due to ion suppression. The calibrant signal 804 may therefore be adjusted by the same loss ratio of the detected reference signal 800 to the expected reference signal 802. For example, if the loss 812 in the reference signal 800 is a drop of 20% below the expected 802, then the calibrant signal 804 may be adjusted proportionally, e.g., divided by 0.8.

With reference back to FIG. 5, the processing element 425 may be configured to compute a loss 812 of the detected reference signal 800 from the expected reference signal 802 and reference a calibration curve, such as shown in FIG. 6 or 7, using the loss 812, so as to quantify calibrant loss due to ion suppression. The loss 812 corresponds to a number of ions of the reference standard lost due to ion suppression. Where the calibrant signal has equivalent response to the reference standard signal, for instance where the reference standard is an isotope labeled analog of the calibrant, the loss in the calibrant signal is proportional to the loss in the reference standard. The processing element 425 may thus adjust the calibrant signal 804 based on the loss of the detected reference signal 800 as represented by the loss 812, irrespective of whether the loss 812 is computed in terms of number of ions or not (ratio/proportion is sufficient). Hence, the system 400 may be configured to compensate for ion suppression by adjusting a calibrant signal based on a detected reference signal and its expected counterpart.

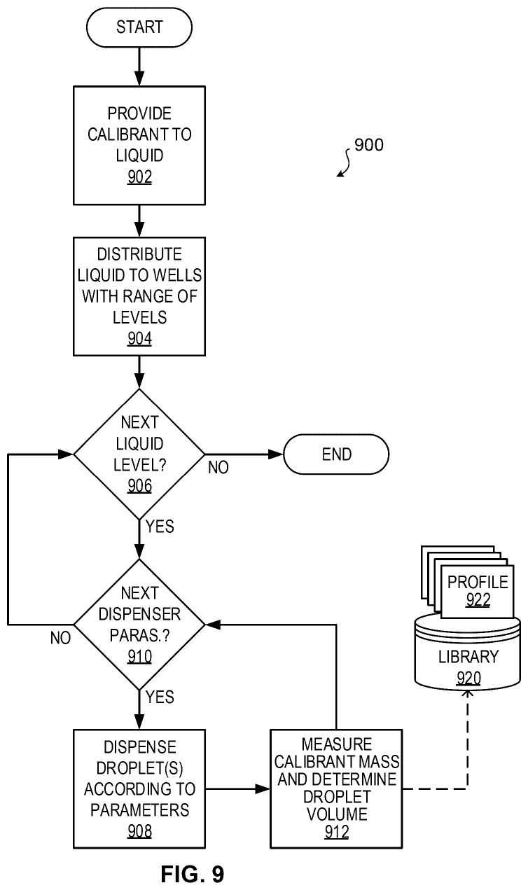

FIG. 9 shows a method 900 of calibrating, or profiling, a droplet dispenser for mass spectrometry, particularly with regard to dispensed droplet volume. The method 900 may be implemented as instructions at a non-transitory machine-readable medium that may be executed by a processing element of a mass spectrometry system. Features and aspect of any of the systems discussed herein may be used with the method 900.

At block 902, a liquid is provided with a calibrant. The liquid may be considered a sample that includes a matrix or other liquid that is expected to contain analytes of interest during post-calibration operations. The calibrant may be selected with regard to the type of liquid sample. The calibrant should be selected as a compound that does not exist in the matrix to be calibrated and should be less likely to experience ion suppression (e.g., quaternary amine surfactants).

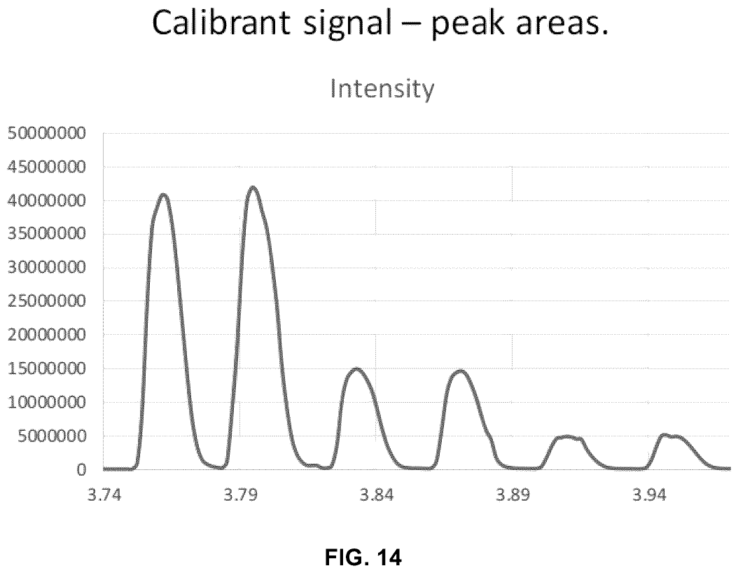

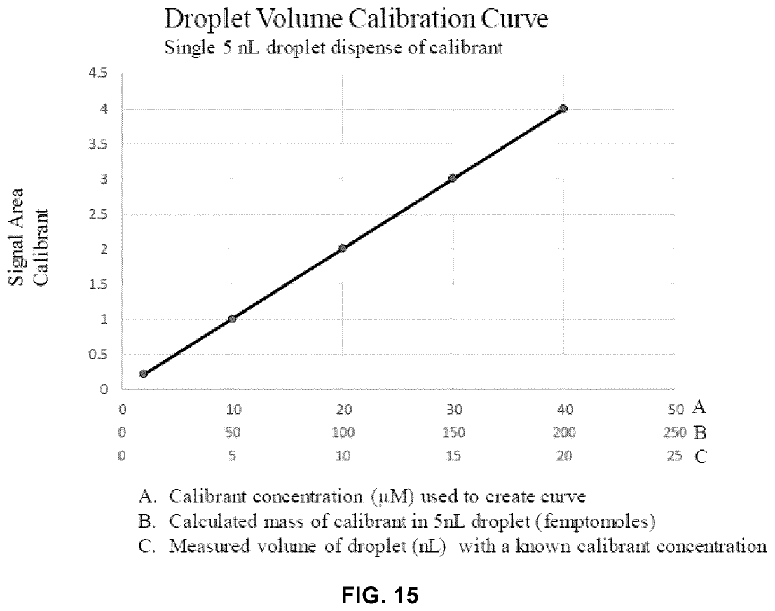

A calibration curve is selected. The calibration curve may have been previously prepared based on predetermined accurately known droplet volumes, such as by a water calibration that uses a sample standard in water. With a reliable way of capturing, transporting, and ionizing the solutes in a droplet the droplet's volume can be determined based on the mass (amount) of calibrant that is measured in a droplet by the mass spectrometer. This is done by preparing a calibration curve relating the mass (amount) of a calibrant in a droplet to the signal from the mass spectrometer. FIG. 14 illustrates a measured mass signal, intensity, for a number of captured and analyzed samples including a calibrant. The peak area of each measurement varies relative to the amount of calibrant contained in each sample. The mass measurement data from FIG. 14, for instance, may be converted into a calibration curve by plotting signal peak area against the known calibrant concentration of the sample, as shown in FIG. 15.

The volume of the droplet used to create a calibration curve should be in the approximate range of the size of the droplets to be measured. For example, if droplet volumes to be measured are in the 1-10 nL range, a volume for the calibration curve droplet of 5 nL would suffice. The mass spectrometer measures the mass of the calibrant in the droplet irrespective of its volume and bulk solvent composition. This measurement is greatly facilitated by the large dilution factor in the OPP capture reservoir ensuring that slight variations in signal due to droplet volume and composition are normalized. Phenomena such as the suppression or enhancement of the ionization efficiency due to the bulk sample composition can be reduced or eliminated in the OPP droplet capture reservoir.

The volume of the droplet used to construct a calibration curve can be delivered and determined in a number of ways. For example, an acoustically dispensed droplet in the low nL volume range (1-10 ug) can be weighted on an analytical balance to determine its volume. It could also be done using the conventional spectroscopic method. Other types of pre-calibrated micro dispensers can also be used for this purpose such as piezo or pressure driven devices. Once the single calibration curve is constructed then that single curve can be used to calibrate the acoustic dispensing parameters for a wide variety of sample compositions with different viscosities and for a range of different droplet dispense volumes. The droplet volume of each sample to be dispensed for analytical measurement can also be checked as long as the sample contains the calibration compound.

The calibration curve will be specific to a specific mass spectrometer, conditions, and methodology because mass spectrometers can have different signal levels for a calibration compound of a single concentration. The signal detected in a mass spectrometer can also change over time as the ion optics accumulate contamination from samples. Drifts in signal can occur within the period of a day depending on the sample load. This will not affect the ability of the calibrated acoustic parameters to deliver accurate and precise volumes using the parameters developed for a particular sample composition, but it will have an impact on measuring the volume of each sample dispensed in real time as the slope of the calibration curve will change. The purpose for real time volume measurement is if the sample viscosity changes from sample to sample in an unpredictable way the volumes dispensed will vary under a single set of acoustic dispensing parameters. Under worst case scenario some samples will not even dispense with those acoustic parameters. This will be detected and noted because of a no signal condition but nothing can be done to correct for it at that time.

The speed of sound for the matrix to be calibrated may also be determined, so as to determine the focal distance for the specific conditions. This may be done by accurately adding the sample matrix into the sample well with a known volume and measuring a time of the flight for the echo signal from the liquid/air interface to determine the speed of sound. For example, for the same 20 ul sample volume of the pure water, the measured liquid level was 3.5 mm, while for the 20 uL sample volume of the unknown volume, the measured liquid level was 2.5 mm if using the water calibration setting. The speed of sound of the matrix is 1.4 times of the speed of sound of water. The new speed of sound for the matrix will be used to adjust the focus of the transducer.

At block 904, the liquid is distributed to a set of wells, where different wells are provided with different levels (depths) of liquid. A range of different liquid levels may be provided to subset of the wells.

Via block 906, for each well having a liquid level of a range of different liquid levels, the well is brought into the influence of the droplet dispenser which is then controlled to dispense droplets into a flowing transport fluid, at block 908, over a range of different droplet dispenser parameters, selected via block 910. Droplet dispenser parameters may include burst number and transducer voltage or other parameter(s) related to energy input to the fluid.

At block 912, the mass of calibrant ions is measured using the mass spectrometer. Then, since the number of droplets dispensed and the calibrant concentration are known, the volume of the droplets may be determined from the calibrant mass. The droplet dispenser parameters and liquid level may then be assigned to an intended droplet volume for the type of liquid sample, the type of well, and/or other characteristics of the liquid and sample setup.

Further, at block 912, the droplet dispenser parameters and liquid level may be stored in a library 920 as associated with the determined droplet volume and the liquid conditions. The library 920 may be implemented by a computer database or similar data storage hardware/software. The library 920 may contain a collection of calibration files organized by type of liquid, type of well, liquid level, and so on, where each file contains a set of droplet dispensing parameters for various intended droplet volumes. Sets of parameters and liquid levels that provide the same drop size for the same fluid and well conditions may be organized into a profile 922. An example profile is shown in Table 1:

| Liquid Level | Burst Number | Voltage |
|---|---|---|
| 1.0 | 200 | 1.5 |
| 1.0 | 400 | 1.2 |
| 1.0 | 800 | 1.0 |
| 1.1 | 250 | 1.5 |
| 1.1 | 450 | 1.2 |
| 1.1 | 875 | 1.0 |
| 1.2 | 290 | 1.5 |
| 1.2 | 500 | 1.2 |
| 1.2 | 1000 | 1.0 |

Each profile may be associated with an intended droplet size, plate type, and liquid class, such that a profile may be loaded based on operational requirements. The profile may then be used to lookup driving parameters (e.g., burst number and voltage) for the measured liquid level in a well. A profile may also include other parameters, such as focal distance.

If the determined droplet volume is unacceptable, then block 910 may be repeated with a parameter of the droplet dispenser adjusted or finetuned based on the determined volume. That is, the droplet dispenser parameters may be modified to adjust the droplet volume determined at block 912, so that the parameters are configured to produce acceptable droplet volumes. For example, for a droplet that is too large, transducer voltage may be reduced. Hence, storing profiles that produce unacceptable droplet volumes may be avoided.

As such, the method 900 quantifies droplet volume for well liquid level acoustic droplet dispenser driving parameters, such as burst number and acoustic transducer voltage. Hence, during future operations, an intended droplet volume can be used to look up suitable profile 922 from the library 920, so that acoustic droplet dispenser driving parameters may be obtained for particular liquid levels.

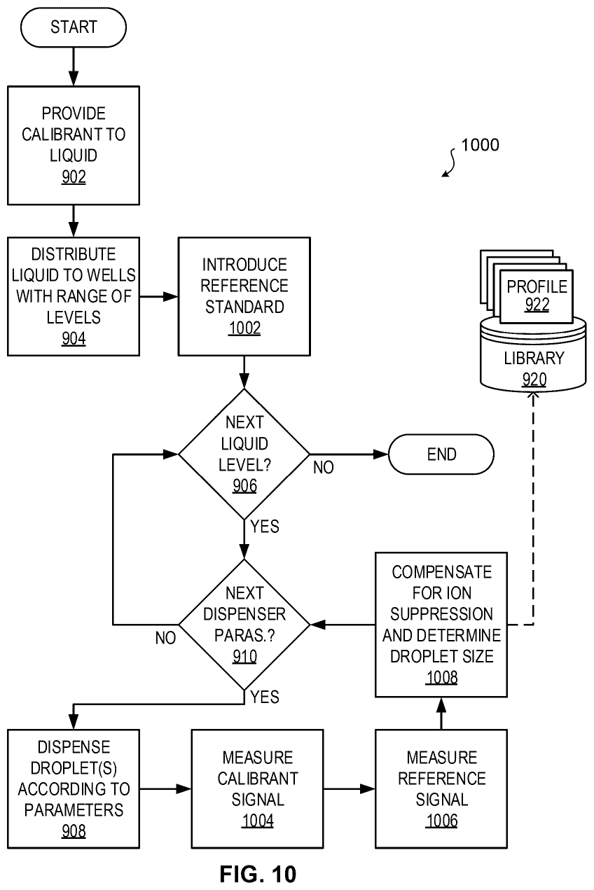

FIG. 10 shows a method 1000 of calibrating, or profiling, a droplet dispenser for mass spectrometry, particularly with regard to dispensed droplet volume. The method 1000 may be implemented as instructions at a non-transitory machine-readable medium that may be executed by a processing element of a mass spectrometry system. Features and aspect of the method 900 and any of the systems discussed herein may be used with the method 1000.

A reference standard of predetermined reference concentration may be introduced into the flowing transport fluid, at block 1002, so as to compensate for ionization suppression. The reference standard may be added to the flowing transport fluid into which droplets containing calibrant are dispensed.

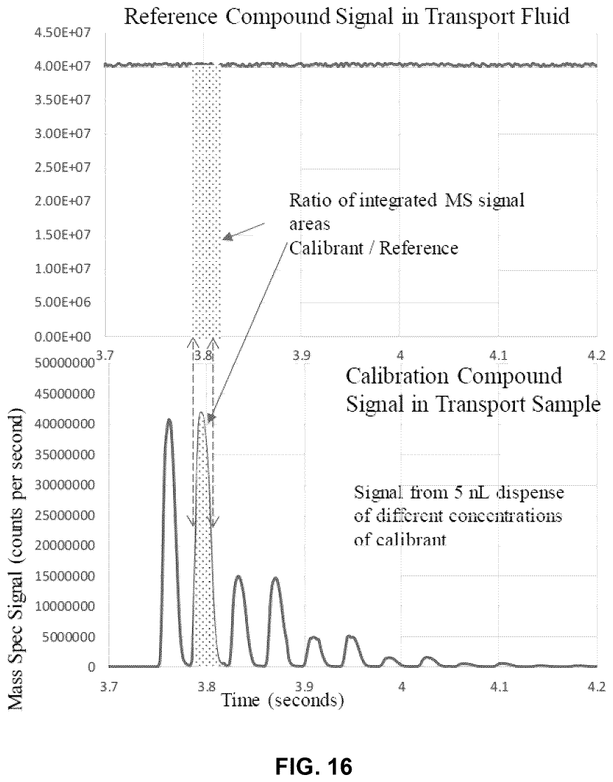

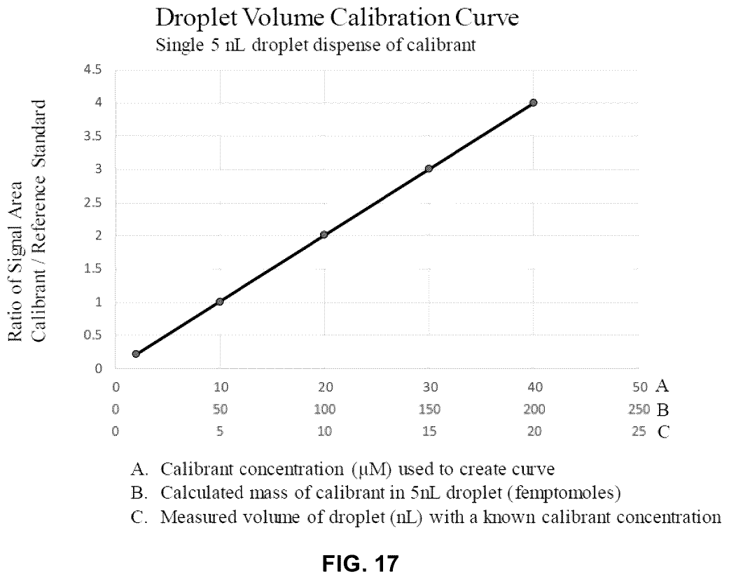

A standard curve may be prepared using a ratio of calibrant and reference standard compound and such a curve may be referred to as a master standard curve. It is prepared in a similar fashion to the curve using a calibration compound of known concentration in the sample to be dispensed. An accurate volume of the calibration compound is dispensed approximately within a broad range of the final targeted volume to which the dispensing parameters will be adjusted to achieve, as described above. The difference is a reference standard of known concentration is added to the transport fluid of the capture probe. The reference compound may be added to the transport fluid in the reservoir that supplies the capture probe, or may be injected as a supplement to the supply of transport fluid supplied to the sample processing region. The relationship to be established is the ratio of calibration compound signal divided by the reference compound signal [C/R] to the mass of the calibration compound dispensed (see FIG. 16). An ideal situation is when the calibration and reference compounds are stable isotope variants of each other. This corrects for all variabilities that could be introduced as a result of the differences in their chemical properties (see FIG. 17).

The master standard curve is referred to as such because it only needs to be prepared once. When constructed with stable isotope variants of calibration and reference compounds it is applicable to a mass spectrometer at different stages of performance degradation throughout its operational lifetime and to all mass spectrometers of different types. This single master standard curve is applicable to all solvent combinations and different sample compositions well as variations in the droplet volumes when doing analytical measurements. One reason for this is, for embodiments that employ a capture probe, the normalization effect on the ionization process due to the large dilution volume of the capture probe (e.g. OPP) referred to earlier. The other is a ratio of signals from the calibrant and reference is used to measure the volume, isotopic variants or otherwise.

Since the master standard curve does not have to be reconstructed on a per sample basis it is applicable to volume measurement on the fly which allows for deviations in sample dispensed volumes to be accounted for during calculation of the sample concentration. The ratio of calibrant and reference compounds can be used to determine the volume from the master standard curve very quickly, typically tens of milliseconds. When samples of unknown composition are encountered the volumes dispensed using existing, suboptimal calibration files can be quickly measured without resorting to the creation of new calibration files. If the volume dispensed is outside of the target range of the acoustic parameters typically power and duration are adjusted and the volume remeasured. Repeat volume measurements and parameter adjustments may be made on individual droplets until target volumes are achieved. If a droplet is not dispensed at all because the acoustic parameters are not correct for this sample the lack of signal would be detected and a rapid recalibration is now possible. This process can be very fast with multiple iterative measurements and adjustments per second and automated. The time this takes will depend on how many iterations of parameter adjustment are required to achieve the targeted volume. In most cases this would take less than one second. Very little sample is required. Calibration files associated with very specific depths at very tight intervals are readily achieved.

Scenarios where the fluid properties of samples can change on a case by case basis are common when analytical measurements are required on the sample. For example, blood from patients experiencing different physiological states will have different hematocrits with widely varying sample viscosities. Human urine from different disease states exhibits similar variabilities and the urine from different species will represent extremes on the viscosity scale. Fermentation media and bioreactors used for the production of valuable pharmaceutical and industrial chemicals will, at different periods of the media's life cycle, have different concentrations of solutes such as polysaccharides that have profound effects on the fluid properties.

The master standard curve can be prepared from a single solvent for the reasons already described. An ideal micro-dispensing solvent can be used as the standard to increase the utility and practicality of this approach. One suitable solvent is dimethyl sulfoxide (DMSO) which has sufficiently high viscosity and surface tension to yield highly stable droplets in the picolitre to nanoliter range. It has a high vapor pressure minimizing errors due to evaporation. Stable and reproducible test solutions and protocols are essential for instrument and method validation and verification.

The reason this single master standard curve is agnostic to sample type, sample dispensed volume, mass spectrometer, and condition of mass spectrometer are twofold. The first is because variations in the ionization efficiency and mass spectrometer response due to variations in these scenarios is accounted for by using the ratio of response of calibrant and reference compounds. Both are affected equally when conditions change. When calibrant and reference compounds are stable isotopic variants of each other all chemical effects are eliminated as they differ only in their nuclear properties, not electronic/chemical properties. In practice the most abundant isotope would be used as the reference compound in the transport fluid because of the greater consumption. The least abundant isotope would be the calibrant in the sample because very small amounts of this more expensive reagent would be used.

The second reason is because of the properties of the capture probe and mass spectrometer interface. For instance, acoustically dispensed samples are in the low nanoliter range. A capture probe such as the OPP instantaneously mixes them upon capture 100-10000-fold in the transport fluid. For all practical purposes what is being delivered to the electrospray ionization region is the transport fluid irrespective of what the composition of the sample is or the droplet volume within the typical range.

Continuing with the method 1000 of FIG. 10, for each combination of droplet dispenser parameters and well liquid level, iterated via blocks 906 and 910, droplets are dispensed, at block 908, and a calibrant signal and a reference signal are measured from ions of the calibrant and reference standard using a mass spectrometer, at blocks 1004 and 1006.

At block 1008, a calibrant signal may be compensated by the reference standard signal as compared to an expected reference signal, so as to reduce or eliminate the effects of ion suppression. That is, ion suppression quantified as a difference between the reference standard signal and the expected reference signal is applied to the calibrant signal. Droplet volume may then be computed based on ion suppression corrected calibrant mass.

As such, the method 1000 quantifies droplet volume for acoustic droplet dispenser driving parameters, such as burst number and acoustic transducer voltage, at various well liquid levels with correction for ionization suppression. Hence, for during future operations, an intended droplet volume can be used to look up a suitable profile 922, for example from a profile library 920 irrespective of ionization suppression that may occur.

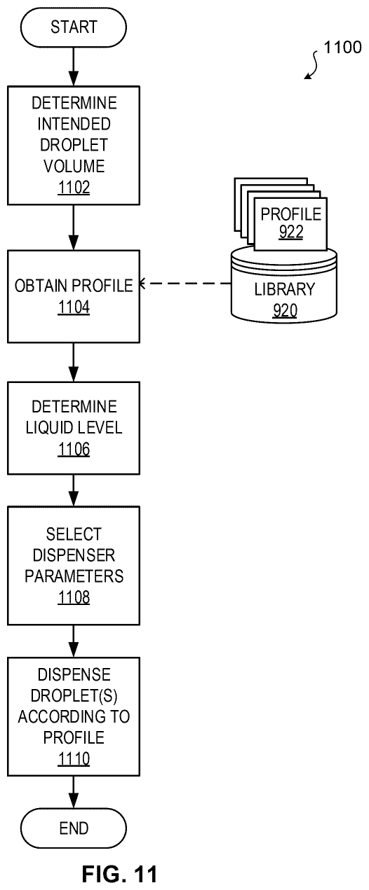

FIG. 11 shows a method 1100 of operating a droplet dispenser for mass spectrometry. The method 1100 may be implemented as instructions at a non-transitory machine-readable medium that may be executed by a processing element of a mass spectrometry system. Features and aspect of the methods 900, 1000 and any of the systems discussed herein may be used with the method 1100.

At block 1102, an intended volume of a droplet to be dispensed from a sample in a sample well is determined. A mass spectrometry process may have a desired droplet volume which, in combination with a burst number, may provide for detection and quantification of an analyte in a sample liquid. The intended droplet volume may be user selected. Other conditions, such as well type and liquid type, are also determined. This information may be inputted into the system by a user.

At block 1104, the intended droplet volume and well and liquid type are used to select a dispenser driving profile 922 from a library 920 of such profiles.

At block 1106, a liquid level of the sample in the sample well is determined.

Then, at block 1108, the liquid level is referenced in the profile to lookup droplet dispensing parameters.

At block 1110, the droplet dispenser is controlled to dispense droplets into a flow of transport fluid according to the selected droplet dispenser parameters. As such, droplet volume may be determined algorithmically prior to the mass spectrometry analysis, so as to reduce sample processing time.

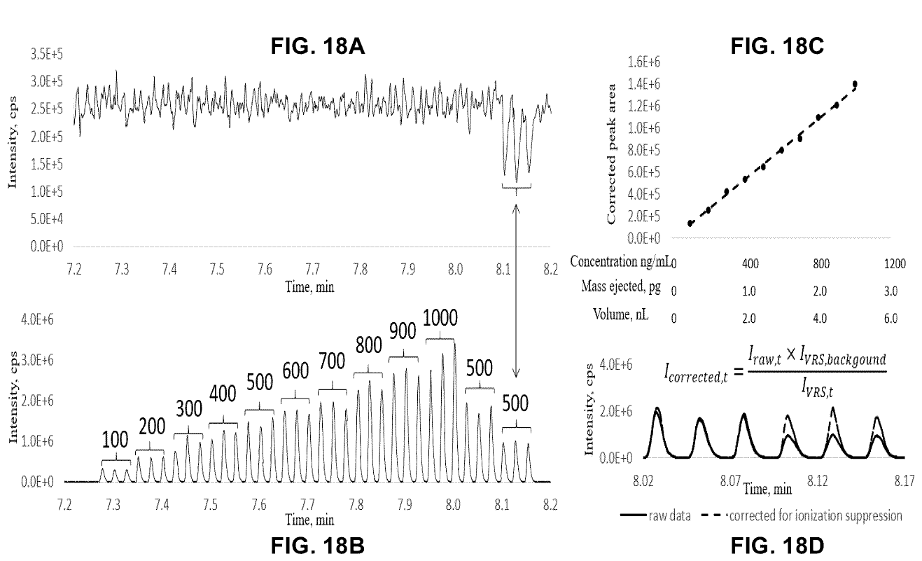

FIGS. 18A-18D show additional plots related to using a reference standard in a calibration to compensate for ionization suppression. A performed test is shown and described.

FIG. 18A shows a multiple reaction monitoring (MRM) ion current of a reference standard, which may be termed a volume reference standard (VRS), with a concentration of 100 μg/mL. The reference standard was continuously introduced into transport liquid flow at a rate of 300 μL/minute.

FIG. 18B shows a sonogram from acoustically dispensed triplicates (three droplets) of calibration compound in 100% water (d3-dextrometrophan) with concentrations indicated in 0.1 ng/ml and an injection rate of 1.5 seconds/sample. Two test samples having different viscosity from water in triplicate (between 8.05-8.2 minutes) were used to measure the volumetric deviation introduced by using acoustic dispensing parameters established for water. (a)=50:50 methanol/water, (b)=rat plasma.

FIG. 18A shows a continuous signal from the VRS. The thorough mixing of the sample with the transport flow (>1000× dilution) ensures any ion current fluctuations incurred with the VS (or analyte) when injected as a droplet are reflected, therefore compensated for, in the VRS trace. One difference between the two modes of sample introduction is the VRS channel provides a constant concentration to the ion source whereas the VS concentration (also analyte and matrix) is time varying, as the peak elutes the concentration entering the ion source is changing. It appears that the degree of ion suppression that occurs is affected by the relative concentrations of matrix and compound being monitored therefore affecting VRS and VS differently.

FIG. 18C shows a master volume calibration curve (MVC). Volumes of sample dispensed of unknown viscosities can be determined from the analyte peak area of its ratio to the volume standard (VS) in the transport fluid flow.

FIG. 18D shows the raw MRM ion current and its corrected ion current using the equation shown. I_{corrected}, t is the corrected intensity at the time point t, I_{raw, t} is the intensity of the raw data at time point t, I_{VRS, background} is the averaged VRS intensity, I_{VRS}, t is the intensity of the VRS at the time point t. Data is smoothed once with 0.5 point.

As can be seen from FIGS. 18A-18D, reduced intensity of the VRS (FIG. 18A) can be used to correct reduced intensity of calibrant (FIG. 18B) due to ion suppression (between 8.05-8.2 minutes; see arrow). The correction can be applied as a ratio of expected VRS signal (background) to measured VRS, so that raw measured intensity of calibrant is increased by the ratio (FIG. 18D). The corrected calibrant intensity can be used to construct the calibration curve (FIG. 18C).

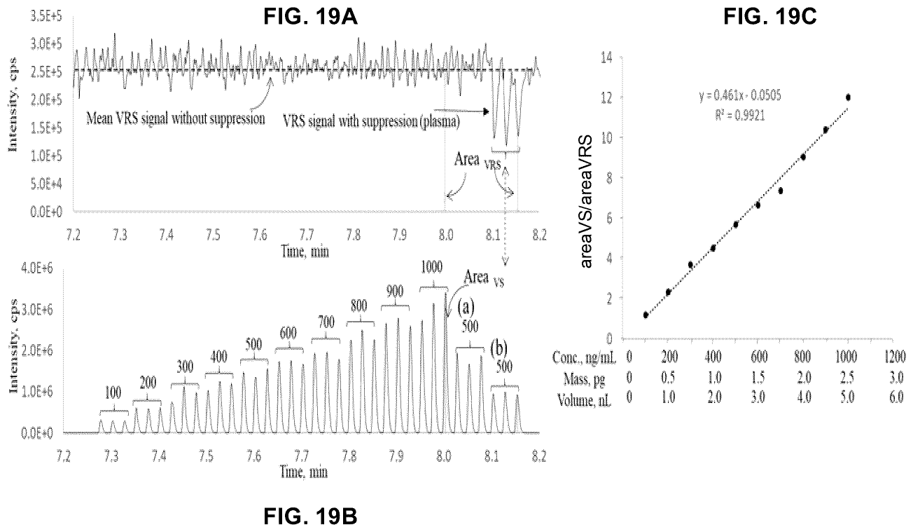

FIGS. 19A-19C show additional plots related to using a reference standard in a calibration to compensate for ionization suppression. FIGS. 19A and 19B are substantially the same as FIGS. 18A and 18B and are based on the same data. FIGS. 19A and 19B additionally indicate vertical regions of area that are relatively narrow and correspond to very short durations. FIG. 19A shows two example areas (area_{VRS}) under the volume reference standard plot. FIG. 19A also shows average VRS plotted with a dashed line. FIG. 19B show two corresponding areas (areaᵥₛ) under the volume standard plot at the same durations as area_{VRS}.

By integrating the signal over a narrow range in the middle of the peaks both channels are simultaneously providing a near constant concentration to the ion source. The integration areas are indicated in FIGS. 19A and 19B. FIG. 19C shows a master calibration curve created using the aqueous standards of different concentrations in FIG. 19A dispensed with validated acoustic parameters for water to deliver 2.5 nL droplets, where each point is an average of the triplicates discussed above. When a sample of unknown fluid property, but spiked with a known concentration of VS, is dispensed its signal will indicate the mass of material in that droplet and, by calculation, its volume. The ratio (areaᵥₛ/area_{VRS}) plotted in FIG. 19C is the area under the plot of FIG. 19B (areaᵥₛ) divided by the area under the plot of FIG. 19A (area_{VRS}) for the same time period.

In view of the above, it should be apparent that the relationship between well fluid level and burst number to dispensed droplet volume can be quantified and profiled to allow for future operations of a droplet dispenser to be made more efficient. Droplet dispenser operational parameters can be associated with well fluid level, burst number, and other sample fluid or well information, so that operational parameters can be quickly obtained for a run of a mass spectrometer or other device that uses the droplet dispenser.

1. A method of calibrating a droplet dispenser for mass spectrometry, the method comprising:
providing a liquid sample including a calibrant;
for each liquid level of a range of different liquid levels:
providing the liquid sample to a set of wells at the liquid level;
over a range of different droplet dispenser parameters, using a droplet dispenser to dispense droplets from the set of wells into a flowing transport fluid;
measuring a calibrant mass of calibrant ions generated from the flowing transport fluid using a mass spectrometer; and
determining volumes of the droplets from the calibrant mass.

2. The method of claim 1, further comprising:
assigning the range of different liquid levels and range of different droplet dispenser parameters to a droplet dispenser profile, and associating the droplet dispenser profile to an intended droplet volume for the liquid sample.

3. The method of claim 2, further comprising:
assigning the droplet dispenser profile to a type of well to which the set of wells belongs.

4. The method of claim 1, further comprising adjusting a parameter of the droplet dispenser based on a determined volume of a droplet.

5. The method of claim 1, further comprising:
introducing a reference standard of predetermined reference concentration into the flowing transport fluid; and
obtaining a reference signal from ions of the reference standard generated from the flowing transport fluid using a mass spectrometer.

6. The method of claim 5, further comprising using the reference signal to correct a measured calibrant mass.

7. The method of claim 1, wherein the parameters include droplet dispenser transducer voltage and burst number.

8. The method of claim 1, wherein the droplet dispenser comprises an acoustic droplet dispenser.

9. A device for calibrating a droplet dispenser for mass spectrometry, the device comprising:
a droplet dispenser;
a sample delivery system positioned to receive droplets dispensed by the droplet dispenser; and
a controller connected to the droplet dispenser, the controller configured to control the droplet dispenser to dispense droplets of a liquid sample from different sets of wells into the sample delivery system using a range of different droplet dispenser parameters, wherein each set of wells has a different level of the liquid sample, wherein the liquid sample includes a calibrant;
the controller further configured to measure a calibrant mass of the calibrant from ions generated from the liquid sample and detected by an ion detector; and
the controller further configured to determine volumes of the droplets from the calibrant mass for each well.

10. The device of claim 9, wherein the controller is further configured to assign the different liquid levels and range of different droplet dispenser parameters to a droplet dispenser profile, and associate the droplet dispenser profile to an intended droplet volume for the liquid sample.

11. The device of claim 10, wherein the controller is further configured to assign each droplet dispenser profile to a type of well to which a set of wells belongs.

12. The device of claim 9, wherein the controller is further configured to adjust a parameter of the droplet dispenser based on a determined volume of a droplet.

13. The device of claim 9, wherein the controller is further configured to obtain a reference signal from ions of a reference standard detected by the ion detector, wherein the reference standard is pumped into the sample delivery system at a predetermined reference concentration.

14. The device of claim 13, wherein the controller is further configured to use the reference signal to correct a measured calibrant mass.

15. The device of claim 9, wherein the parameters include droplet dispenser transducer voltage and burst number.

16. The device of claim 9, wherein the droplet dispenser comprises an acoustic droplet dispenser.

17. A method of operating a droplet dispenser for mass spectrometry, the method comprising:
determining an intended volume of droplet to dispense;
determining a liquid level of a sample in a sample well;
selecting a droplet dispenser profile from a plurality of droplet dispenser profiles based on the intended volume of the droplet;
dispensing droplets into a flow of transport fluid according to parameters in the droplet dispenser profile associated with the liquid level of the sample in the sample well.

18. The method of claim 17, further comprising:
determining a type of the sample; and
selecting the droplet dispenser profile further based on the type of the sample.

19. The method of claim 17, further comprising:
determining a type of the sample well; and
selecting the droplet dispenser profile further based on the type of the sample well.

20. The method of claim 17, wherein selecting the droplet dispenser profile comprises selecting the droplet dispenser profile from a library of droplet dispenser profiles, wherein each droplet dispenser profile in the library associates a burst number and a transducer voltage to sample liquid level.

21. (canceled)
